(19) United States
(12) Patent Application Publication
(10) Pub. No.: US 2025/0132977 A1
(43) Pub. Date: Apr. 24, 2025

(54) COMMUNICATION CONTROL DEVICE, VEHICLE, COMMUNICATION CONTROL METHOD, AND COMMUNICATION CONTROL PROGRAM

(71) Applicants: TOYOTA JIDOSHA KABUSHIKI KAISHA, Toyota-shi (JP); SUMITOMO ELECTRIC INDUSTRIES, LTD., Osaka-shi (JP); SUMITOMO WIRING SYSTEMS, LTD., Yokkaichi-shi (JP); AUTONETWORKS TECHNOLOGIES, LTD., Yokkaichi-shi (JP)

(72) Inventors: Yasuhiro YAMASAKI, Nishin-shi (JP); Kunihiro MIYAUCHI, Toyota-shi (JP); Hideki GOTO, Okazaki-shi (JP); Ikuyoshi OTAKE, Toyota-shi (JP); Ryo YAMANE, Osaka-shi (JP); Yusuke YAMAMOTO, Osaka-shi (JP); Tatsuya IZUMI, Osaka-shi (JP); Hideyuki TANAKA, Osaka-shi (JP); Kenta OGATA, Osaka-shi (JP); Yoshitaka KIKUCHI, Yokkaichi-shi (JP); Hirofumi URAYAMA, Yokkaichi-shi (JP); Darmawan GO, Yokkaichi-shi (JP)

(73) Assignees: TOYOTA JIDOSHA KABUSHIKI KAISHA, Toyota-shi (JP); SUMITOMO ELECTRIC INDUSTRIES, LTD., Osaka-shi (JP); SUMITOMO WIRING SYSTEMS, LTD., Yokkaichi-shi (JP); AUTONETWORKS TECHNOLOGIES, LTD., Yokkaichi-shi (JP)

(21) Appl. No.: 18/728,228

(22) PCT Filed: Jan. 5, 2023
(86) PCT No.: PCT/JP2023/000101

§ 371 Date: Jul. 11, 2024

(30) Foreign Application Priority Data
Jan. 20, 2022 (JP) 2022-007382

(51) Int. Cl. H04L 41/0813; H04L 41/085; H04L 41/0866; H04L 67/00

(52) U.S. Cl. CPC H04L 41/0813; H04L 41/085; H04L 41/0866; H04L 67/34

(57) ABSTRACT

A central ECU serving as a communication control device is provided with a memory and a processor coupled to the memory, the processor receives a change notification relating to a change of an intra-vehicle network communication setting from a center server; and determines whether or not new setting information of the intra-vehicle network that is required in association with the change notification is memorized at at least one of the central ECU and an Ethernet switch. When it is determined that the setting information is memorized at neither the central ECU, or the Ethernet switch, the processor requests the setting information from the center server.

### TECHNICAL FIELD

The present disclosure relates to a communication control device, a vehicle, a communication control method and a program.

### BACKGROUND ART

Japanese Patent Application Laid-Open (JP-A) No. 2017-169044 discloses a software defined networking (SDN) technology that is capable of changing communication settings of a network (below referred to as network settings). An SDN network includes an SDN controller and plural SDN switches. The SDN controller distributes network settings to the SDN switches and the SDN switches implement network control accordingly.

### SUMMARY OF INVENTION

### Technical Problem

A new network setting is required in association with a change in an external system such as an activation of software by an over-the-air (OTA) distribution package, a plug-and-play addition or the like. With the conventional technology, there is concern that communications after a setting change will not run smoothly if an SDN controller or SDN switch is unaware of the new network setting.

The present disclosure is made in consideration of the circumstances described above, and an object of the present disclosure is to provide a communication control device, a vehicle, a communication control method and a program that may reduce the possibility of problems resulting from communications not running smoothly after a change in network communication settings, even if the communication control device or a switching control unit connected to the communication control device are unaware of a new network setting that is required in association with the network setting change.

### Solution to Problem

A communication control device according to a first aspect is for controlling communications of a network and includes: a reception unit that receives a change notification relating to a change of a communication setting of the network; a determination unit that determines whether or not new setting information of the network that is required in association with the change notification is memorized at at least one of the communication control device or a switching control unit connected to the communication control device; and a request unit that, when the determination unit determines that the setting information is memorized at neither the communication control device, nor the switching control unit, requests the setting information from external equipment outside the network.

The communication control device according to the first aspect is a communication control device that controls network communications. The reception unit receives a change notification relating to a change in network communication settings. The determination unit determines whether or not new setting information of the network that is required in association with the change notification is memorized at at least one of the communication control device or the switching control unit connected to the communication control device. When it is determined that the setting information is memorized at neither the communication control unit nor the control unit, the request unit requests the setting information from the external equipment outside the network. Therefore, according to this communication control device, even if the communication control device and the switching control unit are both unaware of the new network setting that is required in association with the change of network communication settings, a possibility of problems resulting from communications not running smoothly after the network setting change may be reduced.

In a communication control device according to a second aspect, in the communication control device according to the first aspect, the change notification is a notification relating to an update of software of equipment connected to the network, and the determination unit determines whether the setting information is memorized, which setting information is based on information of the updated software.

According to the communication control device according to the second aspect, whether or not setting information according to updated software information has been memorized may be determined.

In a communication control device according to a third aspect, in the communication control device according to the first aspect or the second aspect, the reception unit receives the change notification from the external equipment.

According to the communication control device according to the third aspect, a change notification may be received from equipment outside the network.

In a communication control device according to a fourth aspect, in the communication control device according to any one of the first to third aspects, the reception unit receives the change notification together with an update of software to be executed at a control device on the network.

According to the communication control device according to the fourth aspect, a change notification may be received together with a software update.

In a communication control device according to a fifth aspect, in the communication control device according to any one of the first to fourth aspects, the reception unit receives the change notification when a control device is newly connected to the network.

According to the communication control device according to the fifth aspect, a change notification may be received when a new control device is connected to the network.

In a communication control device according to a sixth aspect, in the communication control device according to any one of the first to third aspects, the reception unit receives the change notification when the network is subject to an attack from outside and goes into a fail-safe state.

According to the communication control device according to the sixth aspect, a change notification may be received when the network is attacked from outside.

A vehicle according to a seventh aspect includes: a communication control device according to any one of the first to sixth aspects; at least one switching control unit; and a control device connected to the at least one switching control unit.

According to the vehicle according to the seventh aspect, even when the communication control device and the switching control unit are unaware of a new network setting that is required in association with a change of network communication settings, the possibility of problems resulting from communications not running smoothly after the network setting change may be reduced. As a result, safety in running of the vehicle may be assured.

A communication control method according to an eighth aspect is for controlling communications of a network, in which method a computer executes processing including: receiving a change notification relating to a change of a communication setting of the network; determining whether or not new setting information of the network that is required in association with the change notification is memorized at at least one of a communication control device or a switching control unit connected to the communication control device; and, when the determining determines that the setting information is memorized at neither the communication control device, nor the switching control unit, requesting the setting information from external equipment outside the network.

The communication control method according to the eighth aspect is a communication control method that controls network communications. The computer receives a change notification relating to a change in network communication settings, determines whether new setting information of the network that is required in association with the change notification is memorized at at least one of the communication control device or the switching control unit connected to the communication control device and, when it is determined that the setting information is memorized at neither the communication control unit nor the switching control unit, requests the setting information from the external equipment outside the network. Therefore, according to this communication control method, even if the communication control device and the switching control unit are both unaware of the new network setting that is required in association with the change of network communication settings, a possibility of problems resulting from communications not running smoothly after the network setting change may be reduced.

A communication control program according to a ninth aspect is for controlling communications of a network and causes a computer to execute processing including: receiving a change notification relating to a change of a communication setting of the network; determining whether or not new setting information of the network that is required in association with the change notification is memorized at at least one of a communication control device or a switching control unit connected to the communication control device; and, when the determining determines that the setting information is memorized at neither the communication control device, nor the switching control unit, requesting the setting information from external equipment outside the network.

The communication control program according to the ninth aspect is a communication control program that controls network communications and causes a computer to execute the following processing. The computer receives a change notification relating to a change in network communication settings, determines whether new setting information of the network that is required in association with the change notification is memorized at at least one of the communication control device or the control unit connected to the communication control device and, when it is determined that the setting information is memorized at neither the communication control unit nor the control unit, requests the setting information from the external equipment outside the network. Therefore, according to this program, even when the communication control device and the switching control unit are both unaware of the new network setting that is required in association with the change of network communication settings, a possibility of problems resulting from communications not running smoothly after the network setting change may be reduced.

### Advantageous Effects of Invention

According to the present disclosure, even when a communication control device and a switching control unit connected to the communication control device are unaware of a new network setting that is required in association with a change in network communication settings, the possibility of problems resulting from communications not running smoothly after the network setting change may be reduced.

### BRIEF DESCRIPTION OF DRAWINGS

FIG. 1 is a diagram showing schematic structures of a communication control system according to a first exemplary embodiment.

FIG. 2 is a block diagram showing hardware structures of an ECU of a vehicle according to the first exemplary embodiment.

FIG. 3 is a block diagram showing functional structures of the communication control system according to the first embodiment.

FIG. 4 is a sequence diagram showing a flow of OTA processing of the communication control system according to the first exemplary embodiment.

FIG. 5 is a sequence diagram showing the flow of the OTA processing of the communication control system according to the first exemplary embodiment.

FIG. 6 is a sequence diagram showing the flow of the OTA processing of the communication control system according to the first exemplary embodiment.

FIG. 7 is a flowchart showing a flow of inquiry processing executed at a central ECU according to the first exemplary embodiment.

FIG. 8 is an elevation view showing an example of a display provided to a user according to the first exemplary embodiment.

FIG. 9 is a sequence diagram showing a flow of plug-and-play processing of the communication control system according to the first exemplary embodiment.

FIG. 10 is a sequence diagram showing the flow of the plug-and-play processing of the communication control system according to the first exemplary embodiment.

FIG. 11 is a block diagram showing hardware structures of an ECU of a vehicle according to a second exemplary embodiment.

FIG. 12 is a block diagram showing hardware structures of an ECU of a vehicle according to a third exemplary embodiment.

FIG. 13 is a block diagram showing functional structures of a communication control system according to the third exemplary embodiment.

### DESCRIPTION OF EMBODIMENTS

A communication control system that includes the communication control device of the present disclosure is described. The communication control system is a system that implements communications in a vehicle, is compatible with software defined networking (SDN), and is configured to be capable of acquiring setting information relating to communication settings from a server outside the vehicle as necessary.

### First Exemplary Embodiment

### Overall Structure

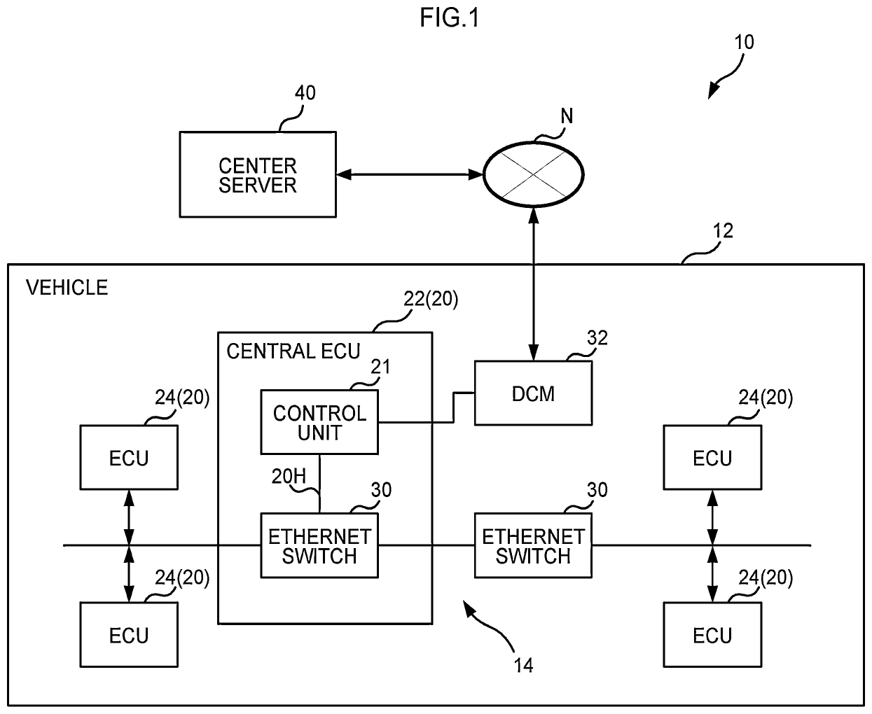

As shown in FIG. 1, a communication control system 10 according to the first exemplary embodiment includes a vehicle 12 and a center server 40 that serves as external equipment. The center server 40 is disposed at an office that conducts management and operations of the communication control system 10, such as an office of a manufacturer of the vehicle 12 or the like. The vehicle 12 and the center server 40 are connected to one another through a public network N.

### Vehicle

An intra-vehicle network 14 in the vehicle 12 according to the present exemplary embodiment includes plural ECUs 20, plural ethernet switches 30 and a data communication module (DCM) 32. The intra-vehicle network 14 is an example of a network. The ECUs 20 include a central ECU 22 that oversees control of the vehicle 12 and ECUs 24 whose communications are controlled by the central ECU 22. Examples of the ECUs 24 include an advanced driver assistance system (ADAS) ECU, a steering ECU, a body ECU and an information system ECU. Each ECU 24 is an example of a control device.

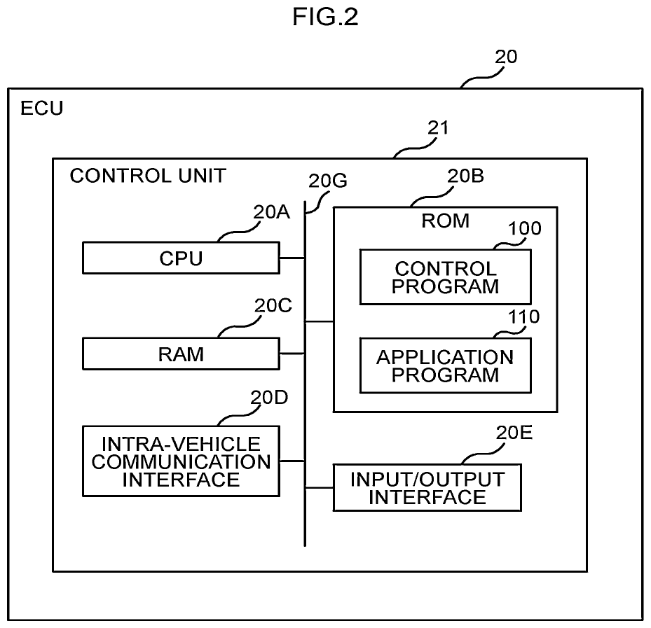

As shown in FIG. 2, each ECU 20 includes at least a control unit 21, which functions as a an SDN controller. The ECU 20 includes the Ethernet switch 30 when required. The control unit 21 includes a central processing unit (CPU) 20A, read-only memory (ROM) 20B, random access memory (RAM) 20C, an intra-vehicle communication interface 20D, and an input/output interface 20E. The CPU 20A, ROM 20B, RAM 20C, intra-vehicle communications interface 20D and input/output interface 20E are connected to be capable of communications with one another via an internal bus 20G.

The CPU 20A is a central arithmetic processing unit that executes various programs and controls respective parts. That is, the CPU 20A reads a program from the ROM 20B and executes the program, using the RAM 20C as a workspace.

The ROM 20B memorizes various programs and various kinds of data. A control program 100 that conducts control of the ECU 20, including communications, is memorized at the ROM 20B according to the present exemplary embodiment. An application program 110 for an application to be executed by the ECU 20 is stored at the ROM 20B. The control program 100 is an example of a communication control program.

The RAM 20C serves as a work area and temporarily memorizes programs and data.

The intra-vehicle communication interface 20D is an interface for connecting with the ECUs 20. This interface employs a communications standard in accordance with Ethernet (registered trademark). The intra-vehicle communication interface 20D is connected to an external bus 20H (see FIG. 1).

The input/output interface 20E is an interface that connects the control unit 21 with other equipment structuring the ECU 20. For example, the input/output interface 20E of the central ECU 22 is connected with the Ethernet switch 30.

The Ethernet switch 30 is a relay device that implements communications over Ethernet (registered trademark). The Ethernet switch 30 according to the present exemplary embodiment functions as an SDN switch. The Ethernet switch 30 implements communications with the ECU 20 in accordance with communication information relating to communication settings of the intra-vehicle network 14. The Ethernet switch 30 is configured to be capable of acquiring the communication information from the control unit 21 or another of the Ethernet switches 30. The Ethernet switch 30 is an example of a switching control unit.

The DCM 32 is a module that implements communications in accordance with a communication standard such as 5G, 4G, LTE or the like. The DCM 32 is connected to the public network N (see FIG. 1). The DCM 32 of the vehicle 12 is connected to the control unit 21 of the central ECU 22, but this is not limiting. The DCM 32 may be embedded at the central ECU 22, an alternative ECU 24 or the like.

### Central ECU

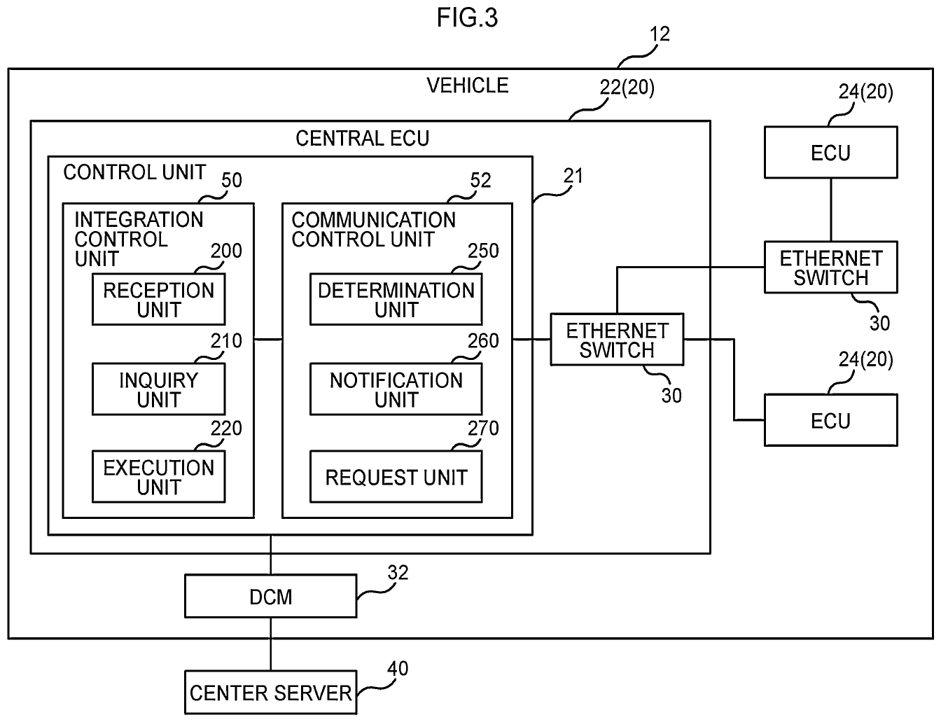

The central ECU 22 is one of the ECUs 20, which is equipped with the control unit 21 and the Ethernet switch 30. In the central ECU 22 according to the present exemplary embodiment, the CPU 20A executes the control program 100 and functions as an integration control unit 50 and a communication control unit 52, which are illustrated in FIG. 3. The central ECU 22 is an example of a communication control device.

The integration control unit 50 controls execution of a download associated with an update of software such as the application program 110 or the like, of plug-and-play configuration when a new one of the ECUs 20 is connected to the intra-vehicle network 14, and the like. The integration control unit 50 includes a reception unit 200, an inquiry unit 210 and an execution unit 220.

The reception unit 200 provides a function for receiving detection of a download of the application program 110, a plug-and-play configuration of the ECUs 20, or the like. The reception unit 200 according to the present exemplary embodiment receives a change notification relating to a change of communication settings of the intra-vehicle network 14.

The inquiry unit 210 provides a function that makes an inquiry to a user of the vehicle 12 as to whether to change a setting of the intra-vehicle network 14.

The execution unit 220, which serves as a reflection unit, provides a function for implementing a setting change of the intra-vehicle network 14 in association with execution of a software download or plug-and-play configuration. When software is being updated, the execution unit 220 according to the present exemplary embodiment reflects setting information at the communication control unit 52 and the Ethernet switch 30 on the occasion of a download being completed. When a plug-and-play configuration is being executed, the execution unit 220 reflects the setting information at the communication control unit 52 and the Ethernet switch 30 on the occasion of the vehicle 12 rebooting (that is, an ignition switch being turned from off to on).

The communication control unit 52 functions as an SDN controller. The communication control unit 52 includes a determination unit 250, a notification unit 260 and a request unit 270.

The determination unit 250 provides a function for determining whether or not the communication control unit 52 and the Ethernet switch 30 have appropriate setting information at the time of a software download or plug-and-play configuration.

The notification unit 260 provides a function for notifying states of the communication control unit 52 and the Ethernet switch 30 to the integration control unit 50. When a malfunction occurs at the intra-vehicle network 14, the notification unit 260 according to the present exemplary embodiment transmits a diagnostic code to the integration control unit 50. Hence, the center server 40 or the like acquires the diagnostic code via the integration control unit 50 and may identify a cause of the malfunction.

The request unit 270 provides a function for requesting appropriate setting information when the communication control unit 52 and the Ethernet switch 30 do not have the appropriate setting information. In this situation, the request unit 270 according to the present exemplary embodiment requests the setting information from the integration control unit 50 or the center server 40.

### Flow of Control

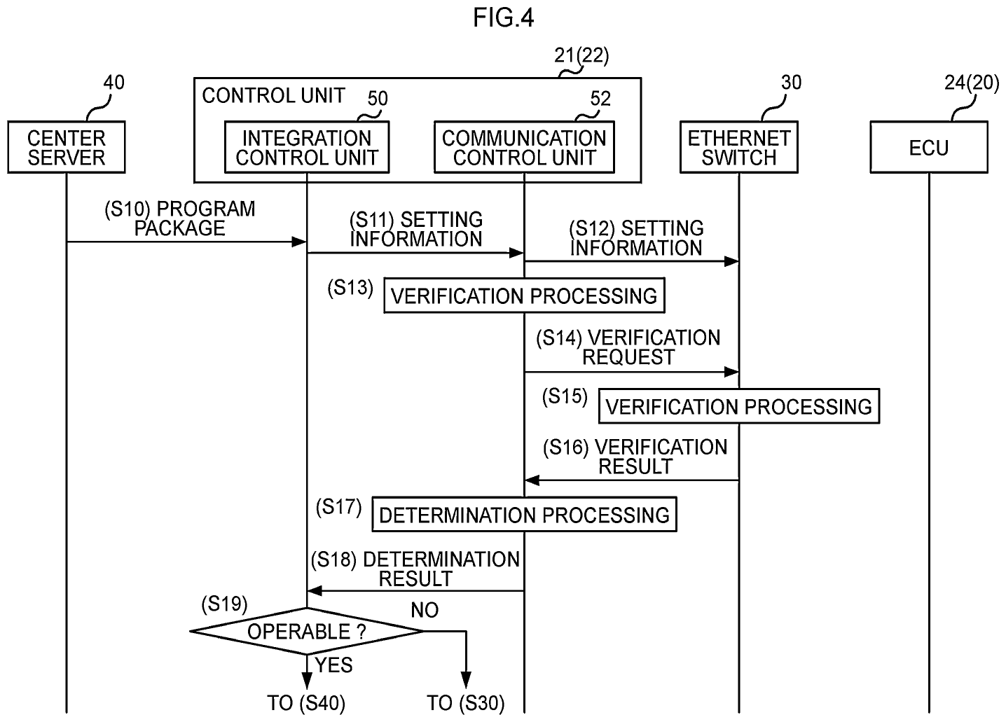

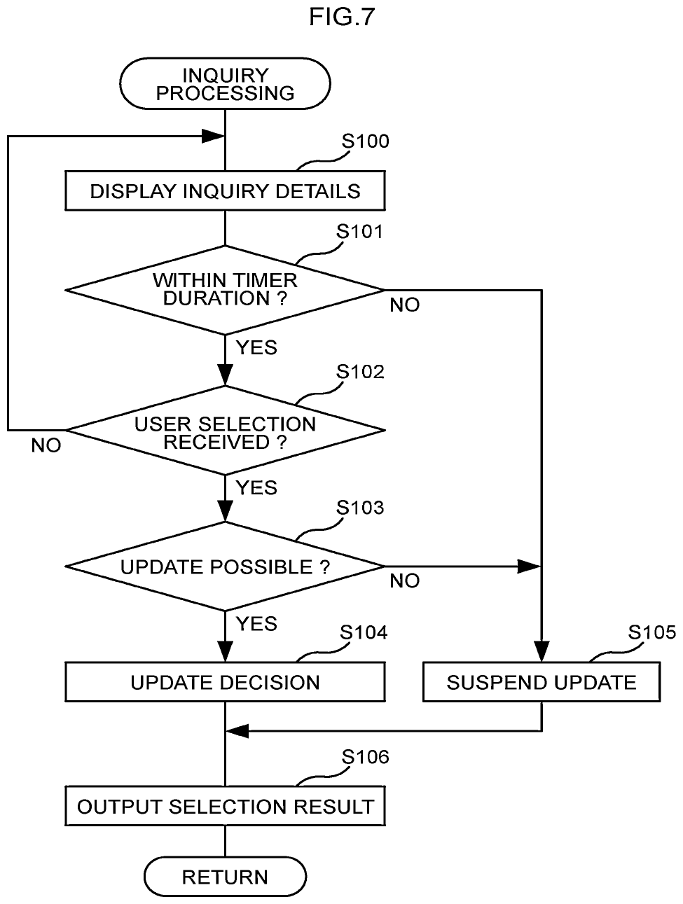

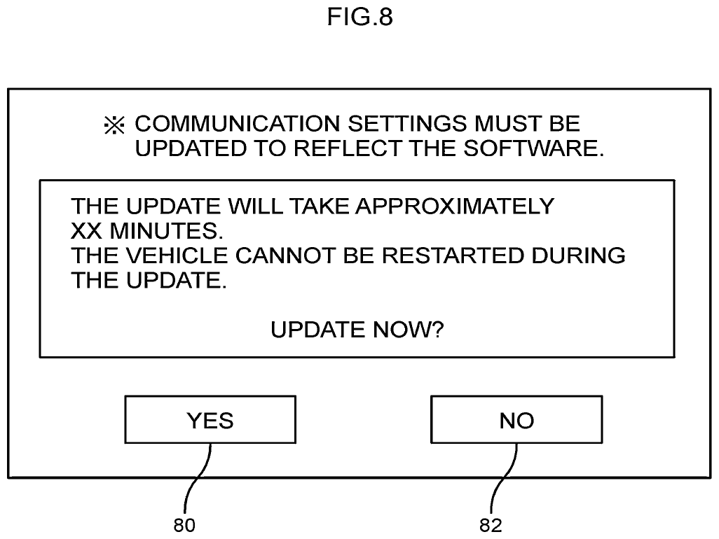

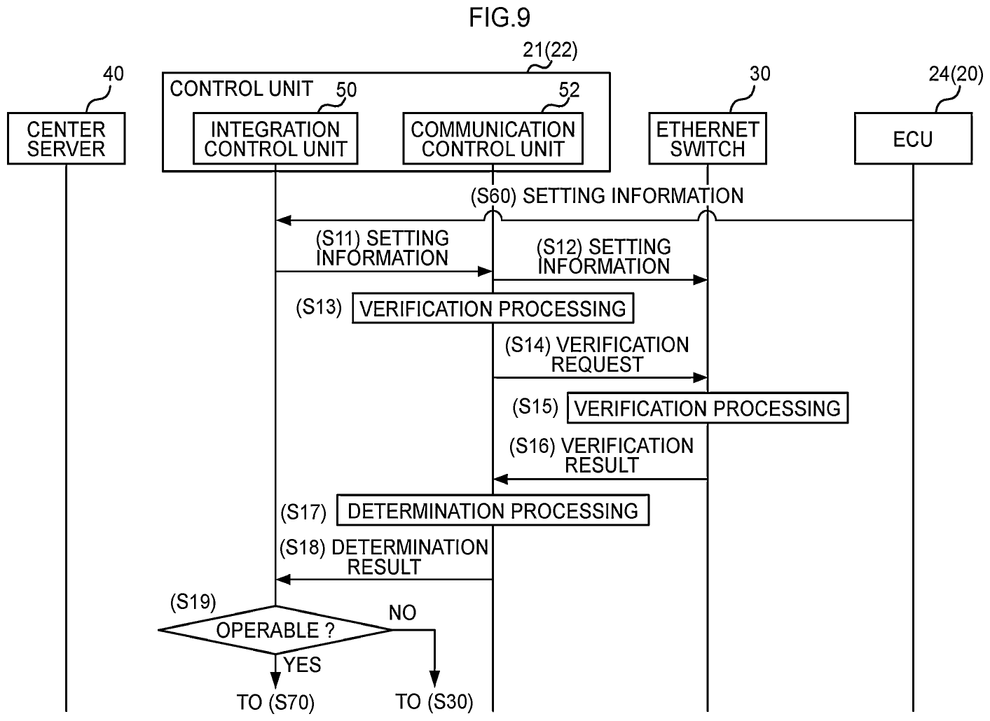

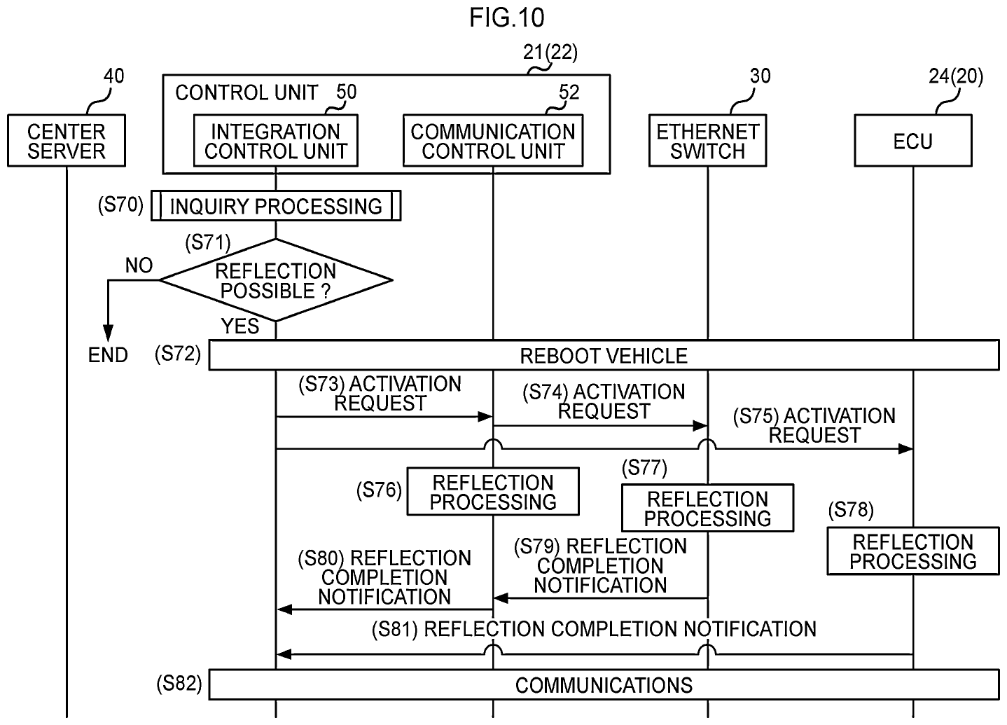

A flow of processing that is executed in the communication control system 10 according to the present exemplary embodiment is described using the sequence diagrams of FIG. 4 to FIG. 6, the flowchart of FIG. 7, the display screen in FIG. 8, and the sequence diagrams of FIG. 9 and FIG. 10. Processing at the central ECU 22 is realized by the CPU 20A functioning as the integration control unit 50 and the communication control unit 52.

First, a flow of overall system processing of the center server 40, the control unit 21 of the central ECU 22, the Ethernet switches 30 and the ECUs 24 is described. In each sequence diagram, only one each of the Ethernet switch 30 and the ECU 24 are illustrated, but this is not limiting. The Ethernet switches 30 and ECUs 24 on the intra-vehicle network 14 are also subjects of this processing.

In step S10 of FIG. 4, the center server 40 transmits a program package to the integration control unit 50 of the control unit 21. The program package includes the application program 110 and setting information for the intra-vehicle network 14.

In step S11, the integration control unit 50 of the control unit 21 transmits the setting information to the communication control unit 52.

In step S12, the communication control unit 52 of the control unit 21 transmits the setting information to the Ethernet switch 30.

In step S13, the communication control unit 52 of the control unit 21 executes verification processing. More specifically, the communication control unit 52 of the control unit 21 verifies whether or not appropriate setting information is memorized. The meaning of the term “appropriate setting information” as used here is intended to include setting information that enables running of the application program 110 downloaded in step S10 on the intra-vehicle network 14.

In step S14, the communication control unit 52 of the control unit 21 makes a verification request to the Ethernet switch 30. More specifically, the communication control unit 52 requests the Ethernet switch 30 to transmit a verification result as to whether or not the Ethernet switch 30 has memorized the appropriate setting information.

In step S15, the Ethernet switch 30 executes the verification processing. More specifically, the Ethernet switch 30 verifies whether or not the appropriate setting information is memorized.

In step S16, the Ethernet switch 30 transmits the verification result to the communication control unit 52 of the control unit 21. More specifically, the Ethernet switch 30 transmits the verification result as to whether or not the Ethernet switch 30 has memorized the appropriate setting information to the communication control unit 52.

In step S17, the communication control unit 52 of the control unit 21 executes determination processing. More specifically, the communication control unit 52 makes a determination as to whether the communication control unit 52 and the Ethernet switch 30 have the appropriate setting information.

In step S18, the communication control unit 52 of the control unit 21 transmits a determination result of the determination processing executed in step S17 to the integration control unit 50.

In step S19, the integration control unit 50 of the control unit 21 makes a determination as to whether at least one of the communication control unit 52 and the Ethernet switch 30 has memorized the appropriate setting information, that is, whether the communication control unit 52 and the Ethernet switch 30 are operable in accordance with the setting information. When the integration control unit 50 determines that the communication control unit 52 and the Ethernet switch 30 are operable (“yes” in step S19), the integration control unit 50 proceeds to step S40. On the other hand, when the integration control unit 50 determines that the communication control unit 52 and the Ethernet switch 30 are inoperable, (“no” in step S19), the integration control unit 50 proceeds to step S30.

Now, a flow of the overall system processing of the center server 40, the control unit 21, the Ethernet switch 30 and the ECU 24 when the integration control unit 50 of the control unit 21 has determined that the communication control unit 52 and the Ethernet switch 30 are inoperable is described.

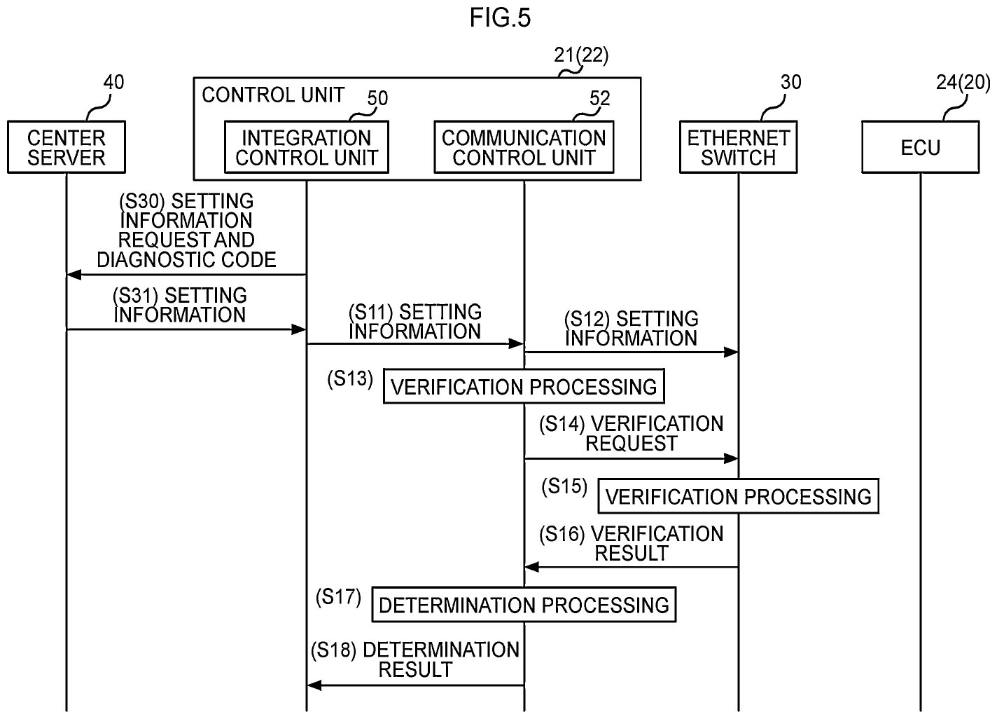

In step S30 of FIG. 5, the integration control unit 50 of the control unit 21 requests setting information to enable operation of the Ethernet switch 30 from the center server 40. When the integration control unit 50 has determined in step S19 that the communication control unit 52 and Ethernet switch 30 are inoperable, a report of inoperability and a diagnostic code indicating the cause of the inoperability are created. The integration control unit 50 transmits, together with a command requesting the setting information, a report that the ECU 20 and Ethernet switch 30 are inoperable on the intra-vehicle network 14 and the diagnostic code representing the cause of the inoperability.

In step S31, the center server 40 transmits setting information to enable the application program 110 to run on the intra-vehicle network 14 to the integration control unit 50 of the control unit 21.

The center server 40, the control unit 21, the Ethernet switch 30 and the ECU 24 then execute processing similar to the processing from step S11 to step S18 illustrated in FIG. 4.

Now, a flow of the overall system processing of the center server 40, the control unit 21, the Ethernet switch 30 and the ECU 24 when the integration control unit 50 of the control unit 21 has determined that the communication control unit 52 and the Ethernet switch 30 are operable is described.

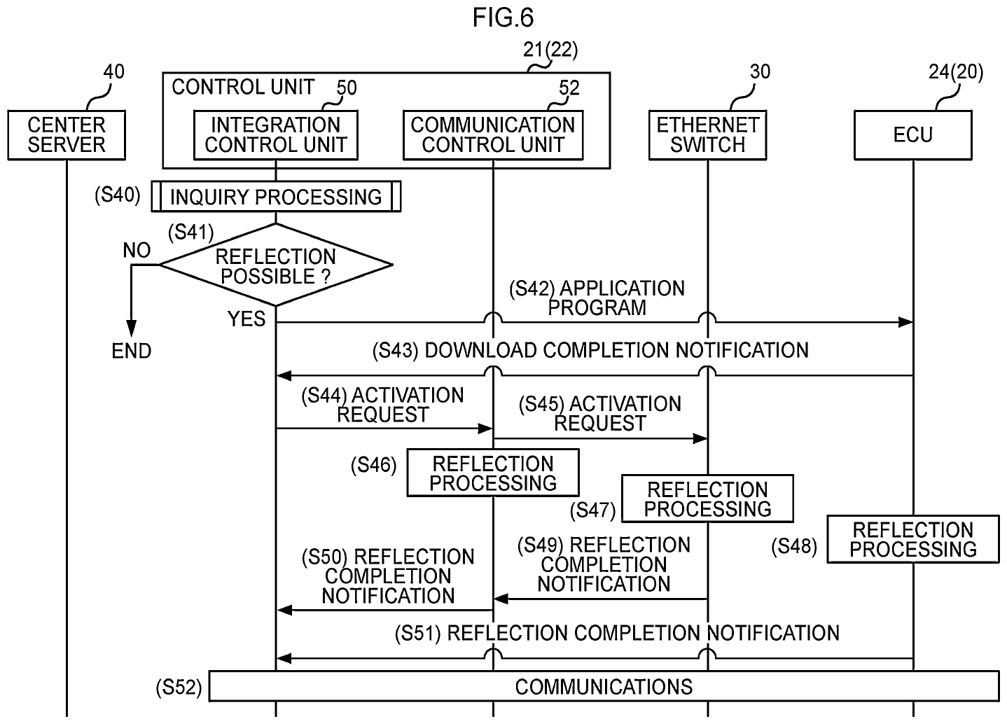

In step S40 of FIG. 6, the integration control unit 50 of the control unit 21 executes inquiry processing. Details of the inquiry processing are described below.

In step S41, the integration control unit 50 of the control unit 21 makes a determination from the processing result of step $40 as to whether the setting information can be reflected. When the integration control unit 50 determines that the setting information can be reflected (“yes” in step S41), the integration control unit 50 proceeds to step S42. On the other hand, when the integration control unit 50 determines that the setting information cannot be reflected (“no” in step S41), the integration control unit 50 ends the processing.

In step S42, the integration control unit 50 of the control unit 21 transmits the application program 110 to the ECU 24 that is a target of installation of the application program 110.

In step S43, the ECU 24 notifies the integration control unit 50 of the control unit 21 that downloading of the application program 110 is complete.

In step S44, the integration control unit 50 of the control unit 21 makes a request for activation to the communication control unit 52. More specifically, the integration control unit 50 requests that the setting information be reflected at the communication control unit 52.

In step S45, the communication control unit 52 of the control unit 21 makes a request for activation to the Ethernet switch 30. More specifically, the communication control unit 52 requests that the setting information be reflected at the Ethernet switch 30.

In step S46, the communication control unit 52 of the control unit 21 executes reflection processing. More specifically, the communication control unit 52 reflects the setting information at the communication control unit 52.

In step S47, the Ethernet switch 30 executes reflection processing. More specifically, the Ethernet switch 30 reflects the setting information at the Ethernet switch 30.

In step S48, the ECU 24 executes reflection processing. More specifically, the ECU 24 reflects the installed application program 110 and the setting information.

In step S49, the Ethernet switch 30 notifies the communication control unit 52 of the control unit 21 that the setting information has been reflected at the Ethernet switch 30.

In step S50, the communication control unit 52 of the control unit 21 notifies the integration control unit 50 of the control unit 21 that the setting information has been reflected at the Ethernet switch 30 and the communication control unit 52.

In step S51, the ECU 24 notifies the integration control unit 50 of the control unit 21 that the installed application program 110 and the setting information have been reflected at the ECU 24.

In step S52, the control unit 21, the Ethernet switch 30 and the ECU 24 start communications in accordance with execution of the application program 110 installed at the ECU 24.

Now, the inquiry processing in FIG. 7 is described.

In step S100 of FIG. 7, the integration control unit 50 causes inquiry details to be displayed on a monitor provided at an instrument panel, a meter panel or the like of the vehicle 12. More specifically, as illustrated in FIG. 8, a message is displayed that an update of communication settings is necessary for reflecting software, which is the application program 110, and a message is displayed that a restart of the vehicle 12 cannot be implemented for a certain duration while the communication settings are being updated. When the reflection of software including the communication setting update is to be executed, a user of the vehicle 12 selects a button 80 displayed as “Yes”. On the other hand, when the reflection of software including the communication setting update is not to be executed, the user selects a button 82 displayed as “No”.

In step S101, the integration control unit 50 makes a determination as to whether the time is within a timer duration (for example, one minute from the start of display of the inquiry details). While the time is in the timer duration (“yes” in step S101), the integration control unit 50 proceeds to step S102. When the timer duration has passed (“no” in step S101), the integration control unit 50 proceeds to step S105.

In step S102, the integration control unit 50 makes a determination as to whether a selection indicating whether or not to update the communication settings has been received. When the integration control unit 50 determines that a selection indicating whether or not to update the communication settings has been received (“yes” in step S102), the integration control unit 50 proceeds to step S103. On the other hand, when the integration control unit 50 determines that no selection indicating whether or not to update the communication settings has been received (“no” in step S102), the integration control unit 50 returns to step S100.

In step S103, the integration control unit 50 makes a determination as to whether the communication settings can be updated. More specifically, the integration control unit 50 makes a determination as to whether the button 80 has been selected. When the communication setting can be updated (“yes” in step S103), the integration control unit 50 proceeds to step S104. On the other hand, when the communication setting cannot be updated (“no” in step S103), the integration control unit 50 proceeds to step S105.

In step S104, the integration control unit 50 decides to update the communication settings.

In step S105, the integration control unit 50 suspends the update of the communication settings.

In step S106, the integration control unit 50 outputs a selection result from the user of the vehicle 12. More specifically, the integration control unit 50 outputs a user selection result, received at the time of the determination in step S102, indicating whether or not to update the communication settings. Then the integration control unit 50 ends the present inquiry processing and returns to step S40 of FIG. 6.

Now, a flow of plug-and-play processing when a new ECU 24 is connected to the intra-vehicle network 14 is described using FIG. 9 and FIG. 10.

The flow of processing of the communication control system 10 shown in FIG. 9 differs from the flow of processing of the communication control system 10 shown in FIG. 4 in that the processing of step S60 is applied instead of the processing of step S10 and that when the result of the determination in step S19 is affirmative, the processing advances to step S70. The verified setting information at a time of plug-and-play configuration is setting information that enables the newly connected ECU 24 to be operated on the intra-vehicle network 14.

Steps that execute the same processing as in the flow of processing of the communication control system 10 shown in FIG. 4 are assigned the same step numbers as in FIG. 4 and descriptions thereof are not given here.

In step S60 of FIG. 9, the ECU 24 transmits the setting information to the integration control unit 50 of the control unit 21.

Now, a flow of overall system processing of the center server 40, the control unit 21, the Ethernet switch 30 and the ECU 24 when the result of the determination in step S19 is affirmative is described.

In step S70 of FIG. 10, the integration control unit 50 of the control unit 21 executes inquiry processing. The flow of the inquiry processing is the same as the flow of the processing shown in FIG. 7.

In step S71, the integration control unit 50 of the control unit 21 makes a determination from the processing result of step S70 as to whether the setting information can be reflected. When the integration control unit 50 determines that the setting information can be reflected (“yes” in step S71), the integration control unit 50 proceeds to step S72. On the other hand, when the integration control unit 50 determines that the setting information cannot be reflected (“no” in step S71, the integration control unit 50 ends the processing.

In step S72, the vehicle 12 reboots. More specifically, the vehicle 12 performs control so as to temporarily turn the ignition switch off and then on again.

In step S73, the integration control unit 50 of the control unit 21 makes a request for activation to the communication control unit 52. More specifically, the integration control unit 50 requests that the setting information be reflected at the communication control unit 52.

In step S74, the communication control unit 52 of the control unit 21 makes a request for activation to the Ethernet switch 30. More specifically, the communication control unit 52 requests that the setting information be reflected at the Ethernet switch 30.

In step S75, the integration control unit 50 of the control unit 21 makes a request for activation to the ECU 24. More specifically, the integration control unit 50 requests that the setting information be reflected at the ECU 24.

In step S76, the communication control unit 52 of the control unit 21 executes reflection processing. More specifically, the communication control unit 52 reflects the setting information at the communication control unit 52.

In step S77, the Ethernet switch 30 executes reflection processing. More specifically, the Ethernet switch 30 reflects the setting information at the Ethernet switch 30.

In step S78, the ECU 24 executes reflection processing. More specifically, the ECU 24 reflects the setting information at the ECU 24.

In step S79, the Ethernet switch 30 notifies the communication control unit 52 of the control unit 21 that the setting information has been reflected at the Ethernet switch 30.

In step S80, the communication control unit 52 of the control unit 21 notifies the integration control unit 50 of the control unit 21 that the setting information has been reflected at the Ethernet switch 30 and the communication control unit 52.

In step S81, the ECU 24 notifies the integration control unit 50 of the control unit 21 that the setting information has been reflected at the ECU 24.

In step S82, the control unit 21, the Ethernet switch 30 and the ECU 24 start communications.

### Overview

In the central ECU 22 according to the present exemplary embodiment, when the communication control unit 52 determines that the Ethernet switch 30 is inoperable in accordance with the setting information, the communication control unit 52 notifies the user of the vehicle 12 with a report that the Ethernet switch 30 is inoperable in accordance with the setting information, and a diagnostic code. Consequently, the user may understand that the Ethernet switch 30 is inoperable in accordance with the setting information and the cause of the inoperability.

In the central ECU 22 according to the present exemplary embodiment, when the communication control unit 52 determines that the Ethernet switch 30 is inoperable in accordance with the setting information, the communication control unit 52 requests setting information to enable operation of the Ethernet switch 30 from the center server 40. Therefore, even when the Ethernet switch 30 is inoperable in accordance with the setting information, the setting information that enables operation of the Ethernet switch 30 may be acquired.

In the central ECU 22 according to the present exemplary embodiment, the integration control unit 50 receives a change notification together with an update of the application program 110 that the ECU 24 is to execute at a control device on the network. Therefore, both the update of the application program 110 and the change notification may be received.

In the central ECU 22 according to the present exemplary embodiment, the integration control unit 50 receives a change notification when a new one of the ECUs 24 is connected. Therefore, the change notification may be received when the ECU 24 is newly connected.

A change notification according to the present exemplary embodiment is a notification relating to a change of the application program 110. The communication control unit 52 of the central ECU 22 makes a determination as to whether setting information based on the updated application program 110 is memorized. Therefore, it may be determined whether or not setting information according to information of the application program 110 has been memorized.

In the central ECU 22 according to the present exemplary embodiment, the integration control unit 50 receives a change notification from the center server 40. Therefore, a change notification may be received from equipment outside the intra-vehicle network 14.

In the central ECU 22 according to the present exemplary embodiment, when the central ECU 22 is to change setting information of the intra-vehicle network 14, the central ECU 22 receives a change notification relating to the change in setting information and subsequently reflects the new setting information at the communication control unit 52 and the Ethernet switch 30 on predetermined occasions. Therefore, according to the present exemplary embodiment, because the communication settings of the communication control unit 52 and Ethernet switch 30 of the intra-vehicle network 14 are reflected on the predetermined occasions, problems in communications when a network setting is changed may be suppressed.

In particular according to the present exemplary embodiment, problems in communications when a communication setting is changed at the time of an OTA software download are suppressed. Furthermore according to the present exemplary embodiment, problems in communications when a communication setting is changed at a time of plug-and-play configuration in association with connection of a new ECU 24 are suppressed.

The vehicle 12 according to the present exemplary embodiment is equipped with the central ECU 22 and at least one Ethernet switch 30 and the ECU 24. According to the present exemplary embodiment of the vehicle 12 as described above, a possibility of problems resulting from communications not running smoothly after a network setting change may be reduced, even if the communication control unit 52 and the Ethernet switch 30 are both unaware of setting information. As a result, safety in running of the vehicle 12 may be assured.

### Second Exemplary Embodiment

The second exemplary embodiment differs from the first exemplary embodiment in the Ethernet switch 30 being a separate structure from the central ECU 22. Below, differences from the first exemplary embodiment are described.

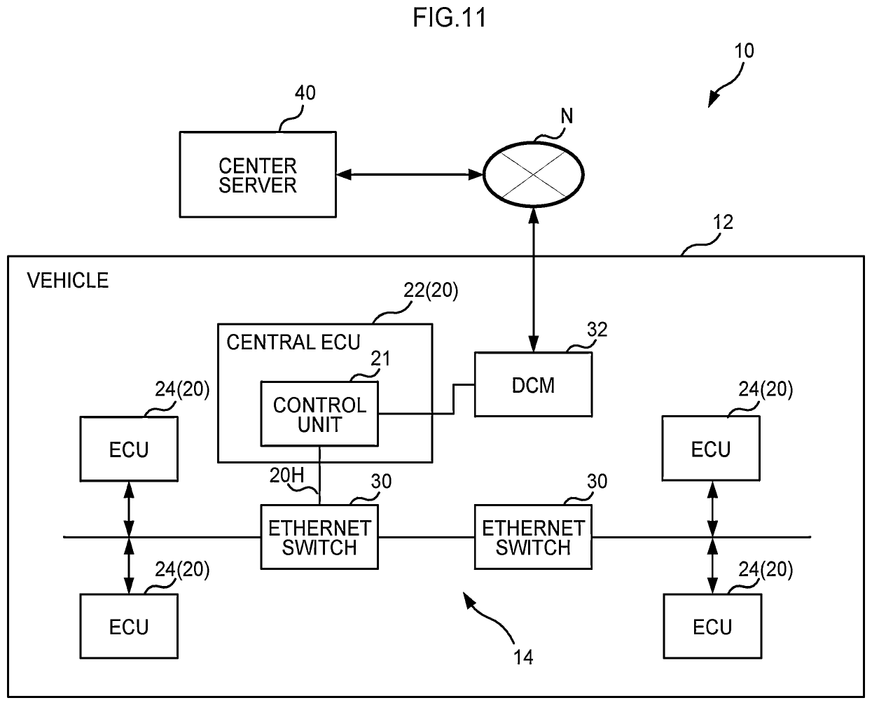

As shown in FIG. 11, the central ECU 22 is structured to include only the control unit 21 and not include the Ethernet switch 30. That is, the Ethernet switch 30 is structured as a separate body from the central ECU 22.

In the present exemplary embodiment, as described above, the Ethernet switch 30 is a separate structure from the central ECU 22. Therefore, according to the present exemplary embodiment, even though the central ECU 22 does not include the Ethernet switch 30, when a network communication setting is changed in a state in which a user is not aware of the change, a subsequent manifestation of the switching control unit not being able to operate in accordance with the new network setting may be suppressed.

### Third Exemplary Embodiment

The third exemplary embodiment differs from the first exemplary embodiment in that functions of the integration control unit 50 of the control unit 21 are provided by a separate ECU 20 from the central ECU 22. Below, differences from the first exemplary embodiment are described.

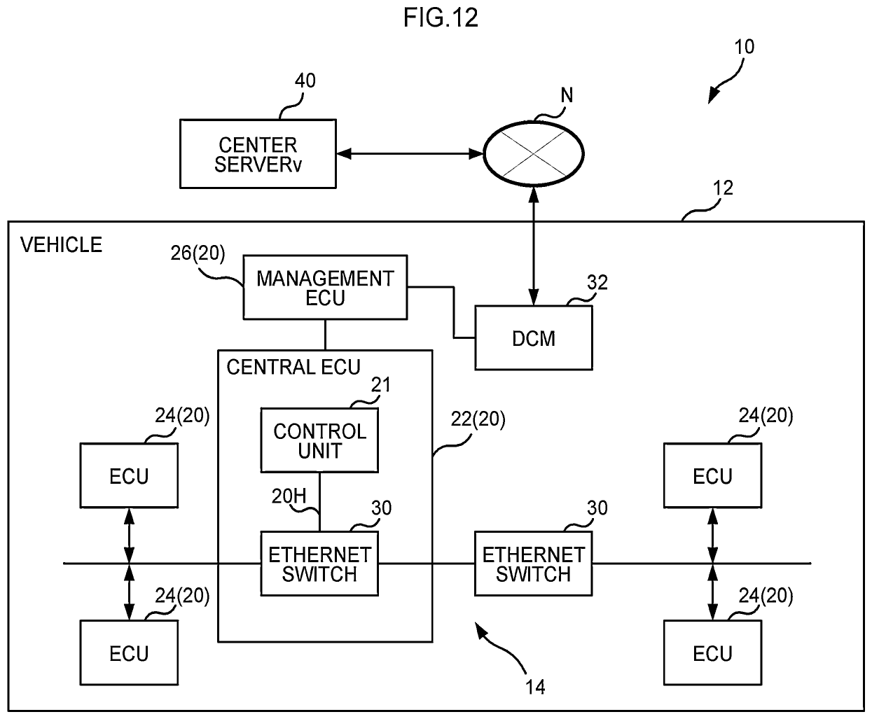

As shown in FIG. 12, in the vehicle 12 according to the present exemplary embodiment, the intra-vehicle network 14 includes the plural ECUs 20, the plural Ethernet switches 30 and the DCM 32. The ECUs 20 include the central ECU 22, the ECUs 24 and a management ECU 26. The DCM 32 is connected to the public network N via the management ECU 26.

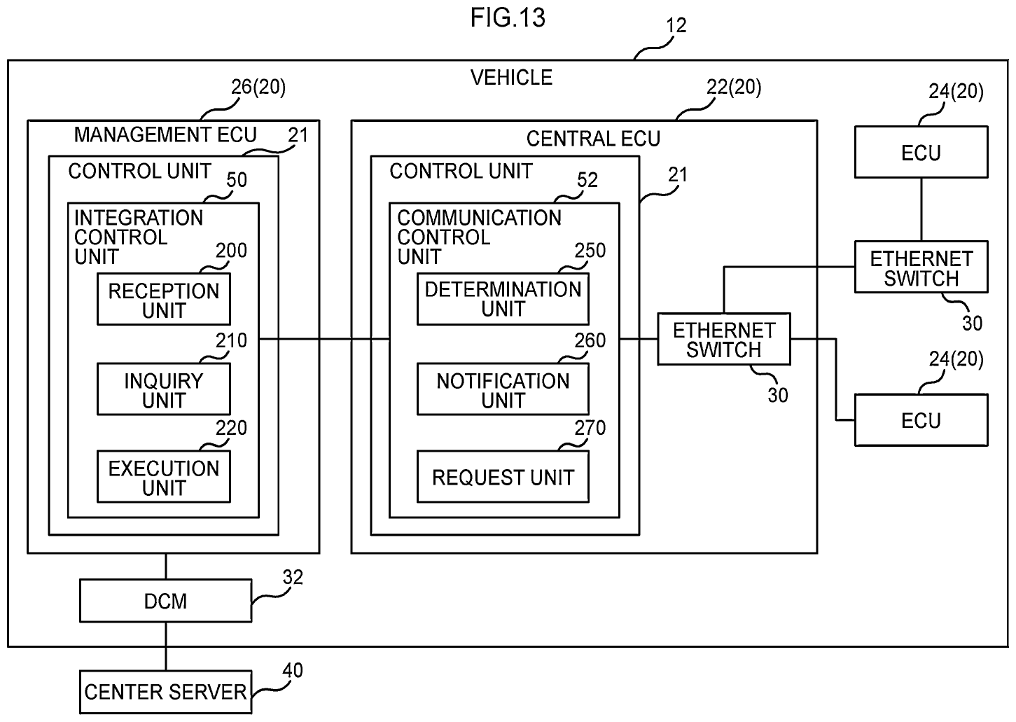

The CPU 20A of the central ECU 22 executes the control program 100 and functions as the communication control unit 52 shown in FIG. 13. Meawhile, the CPU 20A of the management ECU 26 executes the control program 100 and functions as the integration control unit 50 shown in FIG. 13. That is, in the vehicle 12 according to the present exemplary embodiment, the processing by the communication control unit 52 and integration control unit 50 relating to a network setting change is implemented by a plural number of the CPUs 20A.

In the present exemplary embodiment described above, the functions of the integration control unit 50 of the control unit 21 are provided by a separate ECU 20 from the central ECU 22. Therefore, according to the present exemplary embodiment, even though the functions of the integration control unit 50 of the control unit 21 are provided by the separate ECU 20 from the central ECU 22, when a network communication setting is changed in a state in which a user is not aware of the change, a subsequent manifestation of the switching control unit not being able to operate in accordance with the new network setting may be suppressed.

### Notes

In the exemplary embodiments described above, the processing relating to a network setting change is illustrated by processing when software that is the application program 110 is downloaded and processing for plug-and-play configuration when one of the ECUs 24 is added to the intra-vehicle network 14. However, cases in which the processing relating to a network setting change of the present exemplary embodiments is employed are not limited thus. The processing may be employed when constructing the intra-vehicle network 14 during fabrication of the vehicle 12, and when the intra-vehicle network 14 is subject to an attack from outside and goes into a fail-safe state.

In the exemplary embodiments described above, the CPU 20A reads and executes software (programs) but the various processes may be executed by various kinds of processor other than a CPU. Examples of processors in these cases include a PLD (programmable logic device) in which a circuit configuration can be modified after manufacturing, such as an FPGA (field programmable gate array) or the like, a dedicated electronic circuit which is a processor with a circuit configuration that is specially designed to execute specific processing, such as an ASIC (application-specific integrated circuit) or the like, and so forth. The processing described above may be executed by one of these various kinds of processors, and may be executed by a combination of two or more processors of the same or different kinds (for example, plural FPGAs, a combination of a CPU with an FPGA, or the like). Hardware structures of these various kinds of processors are, to be more specific, electronic circuits combining circuit components such as semiconductor components and the like.

In the exemplary embodiments described above, modes are described in which a program is memorized in advance (installed) on a computer readable non-transitory recording medium. For example, the control program 100 of the ECU 20 is memorized in advance at the ROM 20B. However, this is not limiting and a program may be provided in a mode of being recorded on a non-transitory recording medium such as a CD-ROM (compact disc read-only memory), DVD-ROM (digital versatile disc read-only memory), USB (universal serial bus) memory or the like. Modes are also possible in which a program is downloaded from external equipment via a network.

The flows of processing described in the above exemplary embodiments are examples. Unnecessary steps may be removed, new steps may be added, and processing sequences may be rearranged within a scope not departing from the gist of the disclosure.

### Additional Note 1

A communication control device includes a processor and controls communications of a network.

The processor is configured to:
receive a change notification relating to a change of a communication setting of the network;
determine whether or not new setting information of the network that is required in association with the change notification is memorized at at least one of a communication control device or a switching control unit connected to the communication control device; and,
when the determining determines that the setting information is memorized at neither the communication control device, nor the switching control unit, request the setting information from external equipment outside the network.

### Additional Note 2

The communication control device according to additional note 1, in which
the change notification is a notification relating to an update of software of equipment connected to the network, and
the processor determines whether the setting information is memorized, which setting information is based on information of the updated software.

### Additional Note 3

The communication control device according to additional note 1 or additional note 2, in which the processor receives the change notification from the external equipment.

### Additional Note 4

The communication control device according to any one of additional notes 1 to 3, in which the processor receives the change notification together with an update of software to be executed at a control device on the network.

### Additional Note 5

The communication control device according to any one of additional notes 1 to 4, in which the processor receives the change notification when a control device is newly connected to the network.

### Additional Note 6

The communication control device according to any one of additional notes 1 to 3, in which the processor receives the change notification when the network is subject to an attack from outside and goes into a fail-safe state.

The disclosures of Japanese Patent Application No. 2022-007382 are incorporated into the present specification by reference in their entirety.

All references, patent applications and technical specifications cited in the present specification are incorporated by reference into the present specification to the same extent as if the individual references, patent applications and technical specifications were specifically and individually recited as being incorporated by reference.

1. A communication control device for controlling communications of a network, the communication control device comprising:
a memory; and
a processor coupled to the memory, the processor configured to:
receives receive a change notification relating to a change of a communication setting of the network;
determine whether or not new setting information of the network that is required in association with the change notification is memorized at at least one of the communication control device or a switching control unit connected to the communication control device; and
when determining that the setting information is memorized at neither the communication control device, nor the switching control unit, request the setting information from external equipment outside the network.

2. The communication control device according to claim 1, wherein
the change notification is a notification relating to an update of software of equipment connected to the network, and
the processor is further configured to determine whether the setting information is memorized, which setting information is based on information of the updated software.

3. The communication control device according to claim 1, wherein the the processor is further configured to receive the change notification from the external equipment.

4. The communication control device according to claim 1, wherein the processor is further configured to receive the change notification together with an update of software to be executed at a control device on the network.

5. The communication control device according to claim 1, wherein the the processor is further configured to receive the change notification when a control device is newly connected to the network.

6. The communication control device according to claim 1, wherein the the processor is further configured to receive the change notification when the network is subject to an attack from outside and goes into a fail-safe state.

7. A vehicle comprising:
a communication control device according to claim 1;
at least one switching control unit; and
a control device connected to the at least one switching control unit.

8. A communication control method for controlling communications of a network, executed by a processor, the communication control method comprising:
receiving a change notification relating to a change of a communication setting of the network;
determining whether or not new setting information of the network that is required in association with the change notification is memorized at at least one of a communication control device or a switching control unit connected to the communication control device; and,
when the determining determines that the setting information is memorized at neither the communication control device, nor the switching control unit, requesting the setting information from external equipment outside the network.

9. A non-transitory storage medium storing a program for controlling communications of a network, executable by a processor to perform communication control processing, the communication control processing comprising:
receiving a change notification relating to a change of a communication setting of the network;
determining whether or not new setting information of the network that is required in association with the change notification is memorized at at least one of a communication control device or a switching control unit connected to the communication control device; and,
when the determining determines that the setting information is memorized at neither the communication control device, nor the switching control unit, requesting the setting information from external equipment outside the network.
